(19) United States
(12) Patent Application Publication
(10) Pub. No.: US 2005/0289569 A1
(43) Pub. Date: Dec. 29, 2005

(54) Loading device of compact disk player for vehicles

(75) Inventors: Sang-Sick Jung, Kyunggi-do (KR); Seong-Deog Yang, Kyunggi-do (KR); Dong-Youl Kwon, Kyunggi-do (KR)

Correspondence Address: GOTTLIEB RACKMAN & REISMAN PC, 270 MADISON AVENUE, 8TH FLOOR, NEW YORK, NY, 100160601, US

(73) Assignee: SAMSUNG ELECTRO-MECHANICS CO., LTD.

(21) Appl. No.: 10/968,530

(22) Filed: Oct. 19, 2004

(30) Foreign Application Priority Data
Jun. 25, 2004 (KR) 2004-48265

(51) Int. Cl. G11B 17/03; G11B 17/04

(52) U.S. Cl. 720/621

(57) ABSTRACT

The present invention provides a loading device of a compact disk player for vehicles, in which, even when a roller arm, or an upper or lower frame is undesirably deformed, a roller comes into parallel contact with a disk while the disk is inserted into or ejected from the compact disk player. The loading device includes a roller which is provided around a roller shaft which is mounted around an inlet of a main body of the compact disk player to be rotated by a drive motor. The loading device further includes a roller arm which is coupled to a main frame of the main body to support thereon the roller while allowing a vertical movement of the roller; a connection unit to couple the roller shaft to the roller arm; and a drive unit provided on each of both sides of the main frame to vertically actuate the roller shaft.

### BACKGROUND OF THE INVENTION

1. Field of the Invention

The present invention relates generally to compact disk players for vehicles, and more particularly, to a loading device of a compact disk player for vehicles, in which, even when a roller arm, or an upper or lower frame is undesirably deformed, a roller comes into parallel contact with a disk while the disk is inserted into or ejected from the compact disk player.

2. Description of the Related Art

Generally, compact disk players for vehicles are devices to reproduce the recorded information from the optical disks using optical systems.

The general construction of the compact disk players is as follows. The compact disk players each include a turntable to seat a disk thereon, and a disk loading part to load the disk into the interior of the compact disk player and seat the disk on the turntable. The compact disk player further includes a drive means to rotate the turntable, and a clamping unit to prevent the disk from being undesirably removed from the turntable during a rotation of the turntable. The compact disk player further includes an optical pickup unit which is linearly reciprocated in a radial direction of the disk to record information onto the disk or to reproduce recorded information from the disk, and a conveying unit to reciprocate the optical pickup unit.

FIGS. 1 and 2 are views showing a conventional loading device of a compact disk player for vehicles.

As shown in FIGS. 1 and 2, the conventional loading device of the compact disk player includes a roller 40 which conveys a disk into a main body 10 of the compact disk player using friction between the roller 40 and the disk. The conventional loading device further includes a roller arm 50 which supports thereon the roller 40 while allowing a vertical movement of the roller 40. Both the roller 40 and the roller arm 50 are provided around an inlet of the main body 10.

The main body 10 comprises an upper frame assembly 30 and a lower frame assembly 20. An inlet 12, into which the disk is inserted, is defined on the front of the main body 10 by coupling the upper frame assembly 30 to the lower frame assembly 20. The conventional loading device further includes a drive motor 22 which is installed at a predetermined position around the inlet 12. An output shaft 22a of the drive motor 22 extends to a predetermined position on a sidewall of the main body 10. A drive gear 24 is provided on an end of the output shaft 22a.

The lower frame assembly 20 has a coupling notch 26 which is provided on each of predetermined portions of front parts of both sidewalls of the lower frame assembly 20 near the inlet 12. Each of both ends of the roller arm 50 rotatably engages with each of the coupling notches 26. The lower frame assembly 20 further has an elongate slot 28 which is provided on each of predetermined portions of the both sidewalls of the main body 10 in back of each of the coupling notch 26 to be spaced apart from the coupling notch 26 at a predetermined interval. Both ends of the roller 40 are rotatably supported by the elongate slots 28, respectively. Each of the elongate slots 28 is curved to have an arc shape with a center at each of the coupling notches 26.

The roller 40 has an hourglass-shaped appearance, in which the roller 40 is reduced in diameter in the intermediate portion thereof. Thus, the disk is aligned with the intermediate portion of the roller 40 while being inserted into the main body 10 through the inlet 12. A roller shaft 42 is removably and axially installed in the roller 40.

Each of both ends of the roller shaft 42 engages with each of the elongate slots 28 of the lower frame assembly 20 of the main body 10 to rotatably support the roller 40 thereon. A bushing 44 is provided on each of the both ends of the roller shaft 42. As such, the roller shaft 42, coupled to the elongate slots 28 of the upper frame assembly 20, has on the both ends thereof the bushings 44. Due to the bushings 44, the generation of frictional noise is prevented during a rotation of the roller shaft 42. A driven gear 46 is provided on an end of the roller shaft 42.

The roller arm 50 has a plate-shaped appearance. A coupling pin 52 protrudes outwards on each of both ends of the roller arm 50 to be inserted into each of the coupling notches 26 of the lower frame assembly 20 of the main body 10. One of the two coupling pins 52 of the roller arm 50 further extends outward to couple to an intermediate gear 60. The intermediate gear 60 has a double-gear structure. In a detailed description, the intermediate gear 60 comprises a first gear part 62 which engages with the drive gear 24 of the drive motor 22, and a second gear part 64 which engages the driven gear 46 of the roller shaft 42. A pulley 66 is integrally provided on an outer surface of the intermediate gear 60 to transmit a rotational force from the drive motor 22 to a clamping device.

The roller arm 50 has a pair of protrusions 54 which are provided on predetermined positions of an intermediate portion of a front end of the roller arm 50 to be spaced apart from each other at a predetermined interval, thus preventing two or more disks from being inserted into the main body 10. A rubber protector 55 is provided on each protrusion 54. The roller arm 50 further has a spring locking notch 56 which is provided on each of predetermined portions of the both ends of the roller arm 50. Spring locking holes 29 are provided on both sides of a front end of the main body 10 to correspond to the spring locking notches 56, respectively. Springs 70 are interposed between the spring locking notches 56 and the spring locking holes 29, respectively.

The roller arm 50 further has an assembling piece 58 which extends rearwards from a rear portion of each of the both ends of the roller arm 50. Each of the assembling pieces 58 has an assembling groove 58a which is opened rearward. The bushing 44, fitted over each of both ends of the roller shaft 42, is inserted into each of the assembling grooves 58a to actuate the roller 40 and the roller 50 together.

In other words, when the disk is inserted into the main body 10, the roller 40 is moved along the elongate slots 28 of the main body 10 downwards by a distance corresponding to a thickness of the disk. The roller arm 50, coupled to the roller 40 by the assembling pieces 58, is rotated downwards around the coupling pins 52 by a distance corresponding to the movement of the roller 40. When the disk is seated onto a turntable 1 or is ejected to the outside, the roller 40 is moved upwards by the restoring force of the springs 70 provided on the both ends of the roller arm 50. In the conventional loading device having the above-mentioned construction, when the drive motor 22 is operated to rotate the output shaft 22a thereof, the rotational force of the drive motor 22 is transmitted to the intermediate gear 60 via the drive gear 24. Subsequently, the rotational force of the intermediate gear 60 is transmitted to the driven gear 46, so that the roller 40 is rotated by the rotation of the driven gear 46. When the drive motor 22 is rotated in a regular direction, the roller 40 is rotated so as to insert the disk into the main body 10. Otherwise, when the drive motor 22 is reversely rotated, the roller 40 is rotated so as to eject the disk from the main body 10.

However, in the conventional loading device, the roller arm 50 is provided into a single body. Therefore, when a part of the roller arm 50 is undesirably bent, or a portion of the upper or lower frame assembly 30 or 20 around the roller arm 50 is deformed, the roller 40 may remain parallel to the upper frame assembly 30. Therefore, the roller 40 does not come into parallel contact with the disk during a disk insertion or ejection, thus causing operational errors.

That is, if the roller 40 is not parallel to the upper frame assembly 30 during the disk insertion, the roller 40 comes into contact with the disk in an asymmetrical fashion. Therefore, the disk cannot be smoothly inserted into the main body 10, thus causing an operational error.

Furthermore, if the disk does not come into parallel contact with the roller 40, a force to be transferred from the roller 40 to the disk may not be sufficient in comparison with the reference force. Therefore, the number of defective products is increased, and the ability and reliability of the products are deteriorated.

In an effort to overcome the problems experienced in the above-mentioned conventional loading device, another loading device, in which a roller arm is divided into two parts so that two roller arms are individually actuated, thus reducing the operational error of the loading device during a disk insertion or ejection, was proposed in Korean Patent registration NO. 10-427359, entitled ‘a loading device of a compact disk player for vehicles’. This conventional loading device is illustrated in FIG. 3. The construction of the conventional loading device of NO. 10-427359 will be described herein below in detail.

The conventional loading device of NO. 10-427359 loads a disk inserted into a main body 10 of the compact disk player through an inlet of the main body 10, and seats the disk onto a turntable 1 provided in the main body 10. The loading device includes a roller 100 which conveys the disk into the main body 10 using friction between the roller 40 and the disk. The loading device further includes a roller arm 200 which supports thereon the roller 100 while allowing a vertical movement of the roller 100, and a spring 240 which elastically supports the roller arm 200.

As shown in FIG. 3, the roller arm 200 is divided into a left roller arm 210 and a right roller arm 220. The left roller arm 210 and the right roller arm 220 are connected by a connection shaft and are parallel to each other. The left and right roller arms 210 and 220 are rotated around the connection shaft at a predetermined angle. As such, the conventional loading device of NO. 10-427359 has the roller arm 200 which supports thereon the roller 100 and is divided into two parts. Thus, the roller arm 200 comes into parallel contact with the disk, inserted into the main body 10, while the two divided parts of the roller 100 are individually rotated around the connection shaft at the predetermined angle. Therefore, the conventional loading device of NO. 10-427359 is advantageous in that a constant force is applied from the roller 100 to the disk during the disk insertion or ejection, thus preventing an operational error of the loading device, and thereby improving ability and reliability of products.

However, the conventional loading device with the two divided roller arms is problematic in that manufacturing costs are raised, and a process of manufacturing the loading device is complicated by an increase in the number of parts constituting the loading device. To solve the above-mentioned problems, a new loading device, which has the same functions as that of the loading device of NO. 10-427359, but has fewer parts than that of the loading device of NO. 10-427359, is required.

In addition, in the conventional loading device of NO. 10-427359, the springs 240 are coupled to the front part of the roller arm 200. Thus, the springs 240 force the roller arm 240 upwards, even when the disk is inserted in the compact disk player as well as during the disk insertion or ejection. Therefore, when the roller 100 and the roller arm 200 are moved along the elongate slots by the elastic force of the springs 240 during the disk insertion or ejection, a relatively large force is required to actuate the roller 100 and the roller arm 200. To solve the above-mentioned problems, a new loading structure capable of actuating both a roller and a roller arm with a small force is necessary.

### SUMMARY OF THE INVENTION

Accordingly, the present invention has been made keeping in mind the above problems occurring in the prior art, and an object of the present invention is to provide a loading device of a compact disk player for vehicles, in which, even when a roller arm, or a part of an upper or lower frame, around which a roller arm is mounted, is undesirably deformed, a roller comes into parallel contact with a disk while the disk is inserted into or ejected from the compact disk player, thus preventing a disk loading or ejection error.

Another object of the present invention is to provide a loading device of a compact disk player for vehicles, which has a structure capable of reducing the number of parts constituting the loading device in comparison with conventional loading devices, thus reducing the manufacturing costs, and simplifying a manufacturing process thereof, and in which an elastic force of a spring is evenly applied to a roller shaft, so that an operational load is evenly distributed during a disk loading or ejection, thus increasing the reliability of products.

In order to accomplish the above object, the present invention provides a loading device of a compact disk player for vehicles, including a roller provided around a roller shaft which is mounted around an inlet of a main body of the compact disk player to be rotated by a drive motor; a roller arm coupled to a main frame of the main body to support thereon the roller while allowing a vertical movement of the roller; a connection unit to couple the roller shaft to the roller arm; and a drive unit provided on each of both sides of the main frame to vertically actuate the roller shaft.

The roller arm may include on a first end thereof a first hinge shaft which is inserted into a coupling hole, provided on a predetermined portion of the main frame, using a coupling means, and on a second end thereof a second hinge shaft which is inserted into an elongate hole, provided on another predetermined portion of the main frame, to vertically move within a predetermined range. A movement of the second hinge shaft of the roller arm inserted in the elongate hole of the main frame compensates for an operational error caused on the roller arm and upper and lower frames when a disk is inserted into the compact disk player.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view showing a conventional loading device of a compact disk player for vehicles;

FIG. 2 is a perspective view of the conventional loading device of FIG. 1 to show that the assembled loading device is mounted on a lower frame assembly of the compact disk player;

FIG. 3 is a perspective view showing another conventional loading device of a compact disk player for vehicles;

FIG. 4 is an exploded perspective view of a loading device of a compact disk player for vehicles, according to an embodiment of the present invention;

FIG. 5a is a perspective view showing a construction of a roller assembly of the loading device of FIG. 4 to be coupled to a main frame;

FIG. 5b is a left side view of the roller assembly of FIG. 5a which is coupled to the main frame;

FIG. 5c is a right side view of the roller assembly of FIG. 5a which is coupled to the main frame;

FIG. 6 is an exploded perspective view showing a construction of the roller assembly of FIG. 5a;

FIG. 7a is a front view showing a roller bushing of the roller assembly of FIG. 6;

FIG. 7b is a side sectional view of the roller bushing of FIG. 7a;

FIGS. 8a through 8c are side views showing a process of coupling a roller shaft to a roller arm using the roller bushing of FIG. 7a; and

FIGS. 9a and 9b are side views showing an operation of the roller assembly of FIG. 6 by a movement of a lever unit which is provided on each of both ends of the main frame of FIG. 4.

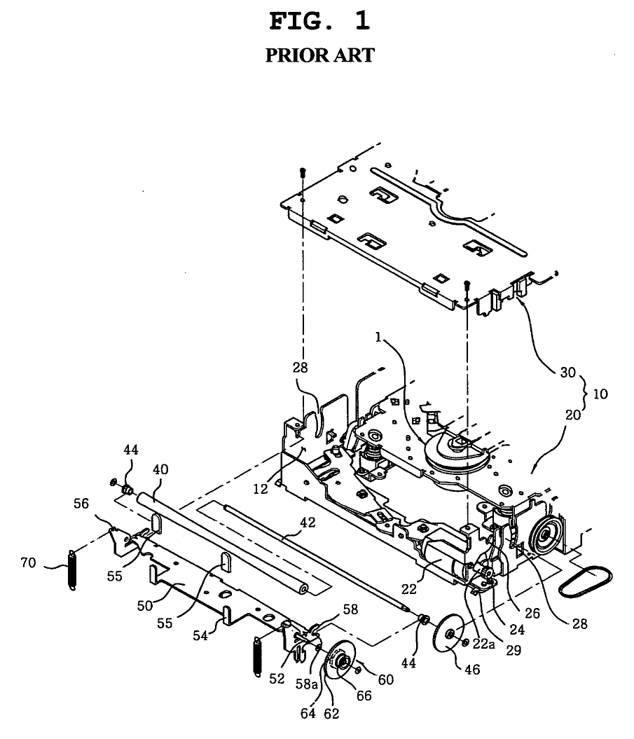

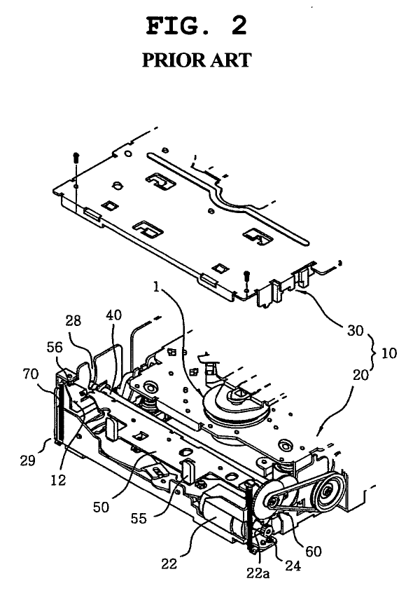

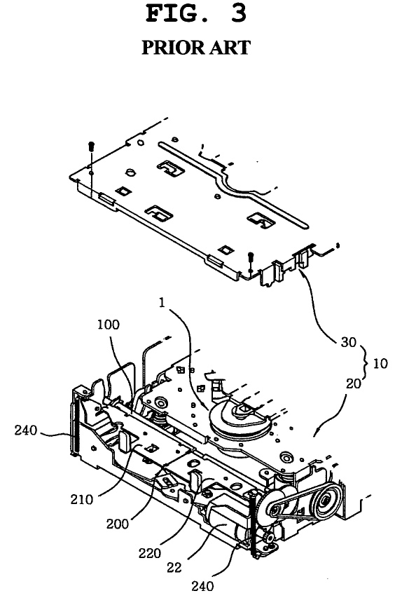

### DESCRIPTION OF THE PREFERRED EMBODIMENTS

Hereinafter, embodiments of the present invention will be described in detail with reference to the attached drawings.

Reference now should be made to the drawings, in which the same reference numerals are used throughout the different drawings to designate the same or similar components.

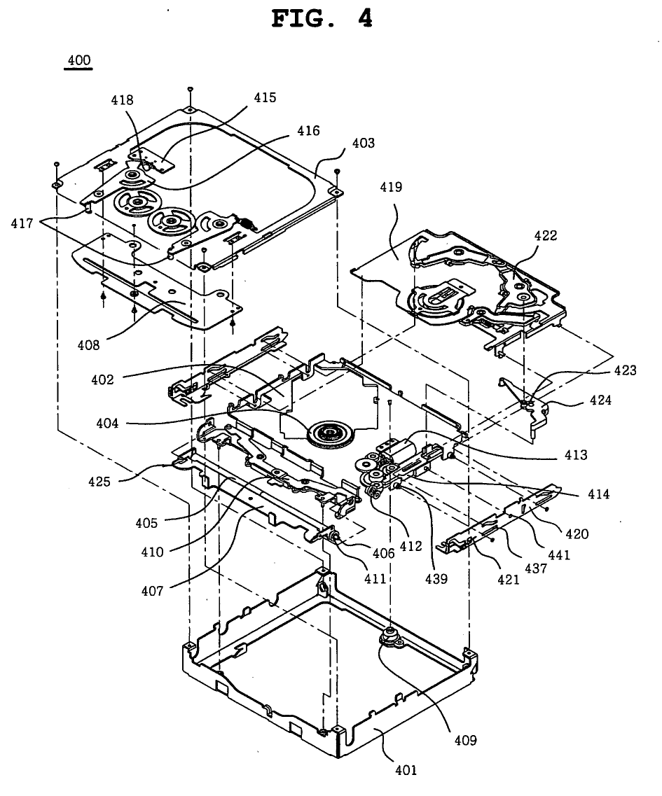

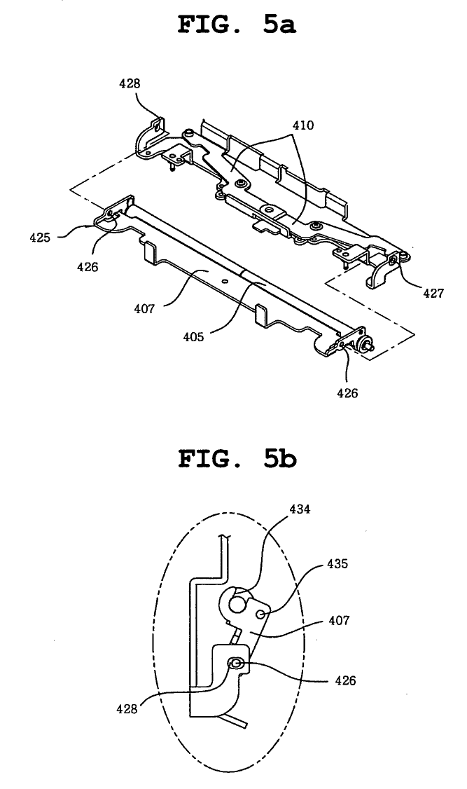

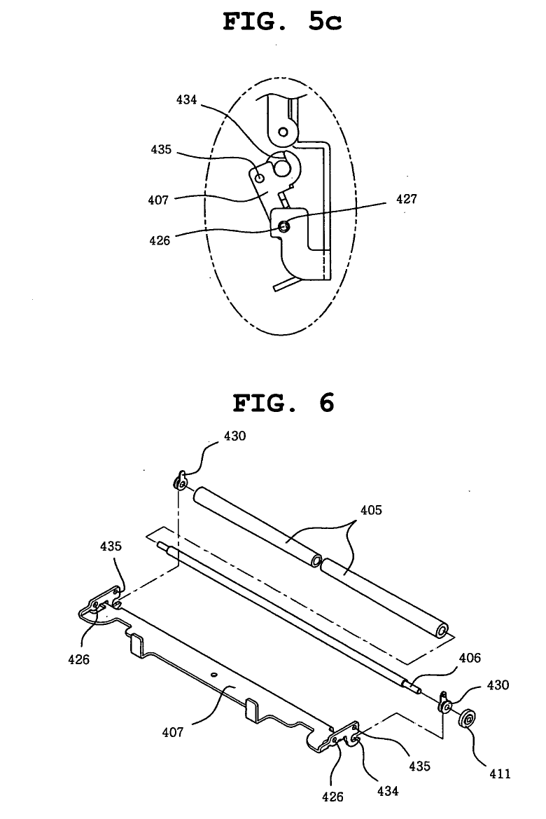

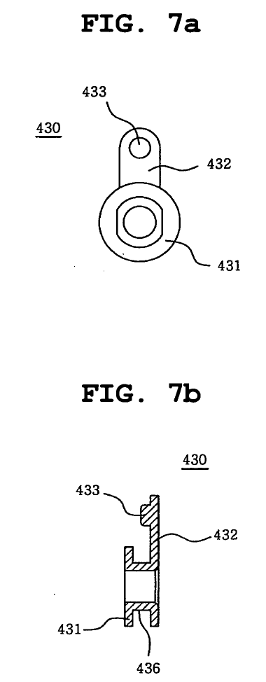

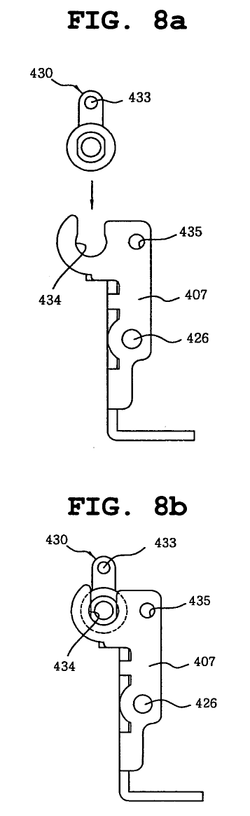

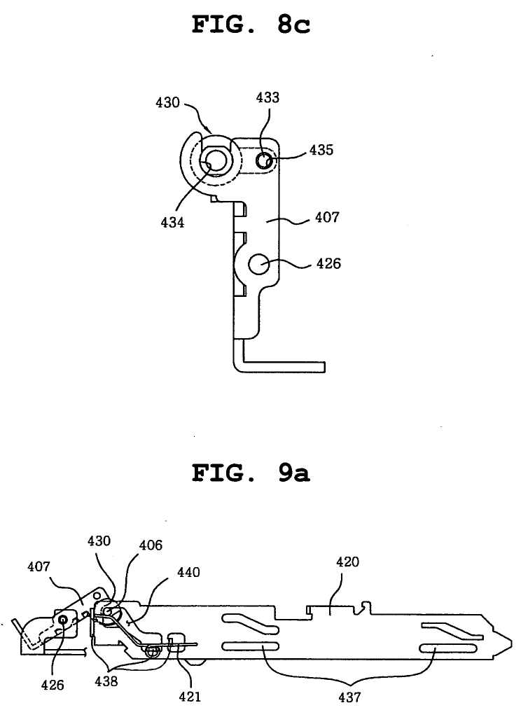

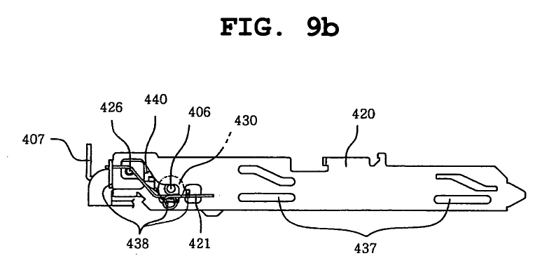

FIG. 4 is an exploded perspective view of a loading device of a compact disk player for vehicles, according to an embodiment of the present invention. FIG. 5a is an exploded perspective view showing a construction of a roller arm 407 of the loading device of FIG. 4 to be coupled to a main frame 402. FIG. 5b is a left side view of the roller arm 407 of FIG. 5a which is coupled to the main frame 402. FIG. 5c is a right side view of the roller arm 407 of FIG. 5a which is coupled to the main frame 402. FIG. 6 is an exploded perspective view showing a construction of the roller assembly 425 of FIG. 5a. FIG. 7a is a front view showing a roller bushing 430 of the roller assembly 425 of FIG. 6. FIG. 7b is a side sectional view of the roller bushing 430 of FIG. 7a. FIGS. 8a through 8c are side views showing a process of coupling a roller shaft 406 to the roller arm 407 using the roller bushing 430 of FIG. 7a. FIGS. 9a and 9b are side views showing an operation of the roller assembly 425 of FIG. 6 by a movement of a lever unit 420 which is provided on each of both ends of the main frame 402 of FIG. 4. The construction of the loading device of the present invention will be described herein below in detail on the basis of the specific parts thereof, but explanation of constructions of the same parts as those of conventional loading devices is not deemed necessary.

The loading device of the compact disk player according to the embodiment of the present invention is as follows, with reference to FIG. 4. As shown in FIG. 4, the loading device loads a disk, which is inserted into an inlet of a main body 400 of the compact disk player, to seat the disk onto a turntable 404 installed in the main body 400. The main body 400 comprises a lower frame 401, the main frame 402 and the upper frame 403. The main frame 402 is placed on a damper 409 provided in the lower frame 401. The upper frame 403 is placed over the main frame 402. In the loading device of the present invention, when the disk is inserted into the compact disk player, the disk's lower and upper surfaces are brought into contact with a roller 405 and a disk guide plate 408, respectively. Thereafter, the disk is seated on the turntable 404, which is provided in the main frame 402, by a rotation of the roller 405.

As such, the loading device of the present invention comprises the lower frame 401, the main frame 402 and the upper frame 403, and has the above-mentioned structure. However, the specific parts of the present invention are the roller 405 and the roller arm 407 which are coupled to each other to be actuated together while being coupled to the main frame 402, the connection unit which couples the roller 405 to the roller arm 407, and the lever unit 420 which actuates the roller 405 and the roller arm 407 together. The specific parts of the loading device of the present invention will be explained herein below in detail.

The loading device of the compact disk player according to the present invention includes the roller 405 which conveys the disk into the main body 400 using a friction between the roller 40 and the disk, and the disk guide plate 408 corresponding to the roller 40. The loading device further includes the roller shaft 406 which is axially provided in the roller 405, and the roller arm 407 which supports thereon the roller 405 while allowing a vertical movement of the roller 405. The loading device further includes a drive unit to actuate both the roller 405 and the roller arm 407 during a disk ejection or loading.

In the loading device of the present invention, a part including the roller 405, the roller shaft 406 and the roller arm 407 is called a roller assembly 425. FIG. 5a is a perspective view showing a construction of a roller assembly 425 of the loading device of FIG. 4 to be coupled to the main frame 402. FIG. 5b is a left side view of the roller assembly 425 of FIG. 5a which is coupled to the main frame 402. FIG. 5c is a right side view of the roller assembly 425 of FIG. 5a which is coupled to the main frame 402. Referring to FIGS. 5a through 5c, the roller assembly 425 has the roller arm 407 which is provided into a single body. Furthermore, a coupling hole of the main frame 402, to which the roller assembly 425 is coupled, is modified into a predetermined shape. As a result, the roller assembly 425 has the same operational function as that of conventional roller arms which are divided into two parts. The above-mentioned operational function is obtained by the roller assembly 425 having the following structure.

The roller assembly 425 is coupled to both ends of the main frame 402. First and second hinge shafts 426 are provided on both ends of the roller assembly 425, respectively. The first hinge shaft 426 of the roller assembly 425 is coupled to a coupling hole 427, which is provided on a predetermined position of the main frame 402 to correspond to the first hinge shaft 426, by a coupling means. The second hinge shaft 426 is coupled to an elongate hole 428, which is provided on another predetermined portion of the main frame 402, to allow the roller assembly 425 to vertically move within a predetermined range.

In a detailed description, the coupling hole 427 of the main frame 402 is coupled to the first hinge shaft 426 of the roller assembly 425 by the coupling means, such as a nut and a bolt. The second hinge shaft 426 of the roller assembly 425 is coupled to the elongate hole 428 which is provided on a sidewall of the main frame 402. That is, the elongate hole 428 vertically extends to a predetermined distance, and only the second hinge shaft 426 vertically moves in the elongate hole 428.

Due to the above-mentioned structure of the roller assembly 425, even in case that the roller 405 or the roller arm 407 constituting the roller assembly 425 is deformed, or a manufacturing error of the roller 405 or the roller arm 407 is caused, or the upper or lower frame 403 or 401 is deformed, the movement of the second hinge shaft 426 of the roller assembly 425 can compensate for the operational error caused on the roller assembly 425. Thus, the roller 405 comes into parallel contact with the disk during the disk insertion or ejection. Furthermore, the roller 405 evenly applies a contact force to the disk placed between the roller 405 and the disk guide plate 408 during the disk insertion or ejection. Due to the movement of the hinge shaft 426 of the roller assembly 425 in the elongate hole 428 of the main frame 402, the roller assembly 425 has the same effect as that of conventional roller arms which are divided into two parts.

FIG. 6 is an exploded perspective view showing a construction of the roller assembly 425 of FIG. 5a. As shown in FIG. 6, the roller assembly 425 includes the roller arm 407, the roller 405 and the roller shaft 406. The roller 405 is divided into two units. Each of the two units of the roller 405 has a taper shape and is reduced in a diameter toward its inner end. Due to the above-mentioned structure of the roller 425, the disk inserted into the compact disk player is aligned with the intermediate portion of the roller assembly 425. The roller 405 is rotated around the roller shaft 406 while slipping on the roller shaft 406. Both the roller shaft 406 and the roller 405, which are coupled to each other, are supported on the roller arm 407.

To provide the above-mentioned coupling structure of the roller assembly 425, in conventional roller assemblies, bushings are used along with additional components, such as washers, etc. Therefore, conventional roller assemblies having a great number of parts are problematic in that the manufacturing costs are increased, and manufacturing efficiency is deteriorated due to a complex manufacturing process. However, in the present invention, only the roller bushing 430 is used to provide the above-mentioned coupling structure of the roller assembly 425. The roller bushing 430 serves as the connection unit to couple the roller shaft 406 to the roller arm 407. The shape of the roller bushing 430 is shown in FIGS. 7a and 7b in detail. FIG. 7a is the front view showing the roller bushing 430. FIG. 7b is the sectional view of the roller bushing 430.

The construction of the roller bushing 430 will be described herein below in detail, with reference to FIGS. 7a and 7b. As shown in FIGS. 7a and 7b, the roller bushing 430 includes opposite sidepieces 431 which are coupled to each other to provide an insert groove 436 between them. The roller bushing 430 further includes a connection part 432 which has a predetermined shape and is provided on one of the opposite sidepieces 431, and a fastening protrusion 433 which has a predetermined shape and is provided on a predetermined portion of the connection part 432. If the fastening protrusion 433 has a protruded shape, the fastening protrusion 433 may have any shape. Preferably, the fastening protrusion 433 has a circular protrusion with a rounded edge to efficiently couple the roller shaft 406 to the roller arm 407.

A process of coupling the roller shaft 406 to the roller arm 407 using the roller bushing 430 is illustrated in FIGS. 8a through 8c. The above-mentioned coupling process will be described herein below, with reference to FIGS. 8a through 8c.

As shown in FIG. 8a, the roller bushing 430 coupled to the roller shaft 406 is inserted into a roller bushing assembling seat 434 of the roller arm 407 in a direction shown by the arrow of FIG. 8a. Then, the roller bushing 430 is coupled to the roller arm 407, as shown in FIG. 8b. Thereafter, the connection part 432 of the roller bushing 430 is rotated around the roller shaft 406, until the fastening protrusion 433 of the roller bushing 430 is locked to a locking hole 435 which is provided on a predetermined portion of the roller arm 407. Thus, the process of coupling the roller shaft 406 to the roller arm 407 using the roller bushing 430 is completed. The coupling of the roller shaft 406 to the roller arm 407 is shown in FIG. 8c.

As described above, the roller shaft 406 is coupled to the roller arm 407 using only the roller bushing 430 through the above-mentioned coupling process. Therefore, the loading device of the present invention does not require additional parts, such as washers, used in the conventional roller assemblies. As such, due to the reduction in the number of the elements used for the roller assembly coupling, the roller assembly coupling process of the present invention is more simply executed. Furthermore, efficiency of the manufacturing process of the roller assembly 425 is increased.

FIGS. 9a and 9b are side views showing an operation of the drive unit provided on each of the both sides of the main frame 402. The detailed construction of the drive unit is shown in FIG. 4. The construction of the drive unit, provided on each of the both sides of the main frame 402, will be described herein below in detail, referring to FIG. 4. The drive unit includes the lever unit 420 and an elastic unit 421.

The elastic unit 421 applies an elastic force to the roller shaft 406. The elastic unit 421 may comprise a bar spring or a leaf spring. Preferably, the leaf spring is used as the elastic unit 421 to simplify the structure of the drive unit, thus increasing efficiency of the products. The elastic unit 421 is supported by a predetermined number of support protrusions 438 which is provided on the lever unit 420.

The construction of the lever unit 420 will be described herein below. The lever units 420 of the drive units provided on the both sides of the main frame 402 comprise first and second lever units 420 which are respectively provided on right and left sides of the main frame 402. Each of the first and second lever units comprises a predetermined number of slide holes 437 which is provided on the lever 420 to receive therein a predetermined number of connection protrusions 439 which is provided on each of the both sides of the main frame 402. Thus, the lever 420 is moved under the guide of the connection protrusions 439. The lever unit 420 further includes an S-shaped cam hole 440 which is provided on a front part of the lever unit 420 to allow the roller shaft 406 to vertically move during the disk ejection or loading. The support protrusions 438 are provided on the lever unit 420 to support thereon the elastic unit 421 which is provided to apply upwards the elastic force to the roller shaft 406 while the roller shaft 406 is placed in an upper portion of the S-shaped cam hole 440. Particularly, the first lever unit 420 further comprises on a predetermined portion thereof a rack gear coupling hole 441 to couple the first lever unit 420 to a rack gear 414 which is provided on a predetermined portion of the main frame 402 to transmit a drive force from a drive motor 413 to the first lever unit 420.

The drive units, each including the lever unit 420 with the above-mentioned construction, allow the vertical movement of the roller shaft 406 under the guide of the S-shaped cam holes 440 according to forward and backward movements of the lever unit 420 during the disk loading or ejection. The loading device of the present invention has a structure that reduces an operational load required for the movement of the lever units 440. In a detailed description, the conventional loading devices are constructed so that elastic forces of springs are applied to roller shafts where the roller shafts are placed in S-shaped cam holes. Therefore, in the conventional loading devices, large operational loads are required to actuate the roller shafts. However, in the loading device of the present invention, the elastic forces of the elastic units 421 are applied to the roller shaft 406 only when the roller shaft 406 is placed in the upper portions of the S-shaped cam holes 440 of the lever units 420. During the disk loading process, that is, when the roller shaft 406 is placed in lower portions of the S-shaped cam holes 440, the roller shaft 406 is not affected by any force including the elastic force of the elastic units 421. Therefore, the loading device of the present invention is advantageous in that the operational load required for the movement of the lever units 440 is reduced.

FIGS. 9a and 9b are side views showing the operation of the roller assembly 425 by the movement of the lever unit 420. FIG. 9a is a side view showing the roller shaft 406 placed in the upper portion of the S-shaped cam hole 440 during the disk insertion or ejection. As shown in FIG. 9a, the upward elastic force of the elastic unit 421 is applied to the roller shaft 406 while the roller shaft 406 is placed in the upper portion of the S-shaped cam hole 440. By the above-mentioned elastic force, the disk is moved between and parallel to the roller 405 and the disk guide plate 408 during the disk insertion or ejection. Thus, the disk is more efficiently inserted into or ejected from the compact disk player.

FIG. 9b is a side view showing the operation of both the lever unit 420 and the elastic unit 421 during the disk loading process. As shown in FIG. 9b, the roller shaft 406 is placed in the lower portion of the S-shaped cam hole 440 during the disk loading process. In this case, the roller shaft 406 is not affected by any elastic force. Thus, the operational load required for the forward or backward movement of the lever unit 420 is reduced.

The operation of the loading device having the above-mentioned construction will be described herein below, with reference to FIGS. 4 and 9.

Referring to FIG. 4, when the disk is inserted between the disk guide plate 408 and the roller 405, an outer edge of the disk pushes a guide pin 417 of each of disk guide arms 416 provided on predetermined portions of the upper frame 403. Then, one of the disk guide arms 416 pushes a switch lever 417 of a switch assembly 415 provided on a predetermined portion of the upper frame 403. Thus, the switch assembly 415 is turned on to operate the drive motor 413.

By the drive motor 413 operated through the above-mentioned process, a plurality of gear units 412, coupled to the drive motor 413, is actuated. Thus, the gear units 412 actuate a roller gear 411 coupled to the roller shaft 406, so that the roller 405 is rotated. Therefore, the disk is moved by the rotation of the roller 405 until being precisely seated onto the turntable 404 which is provided in the main frame 402. At this time, the roller shaft 406 is placed in the upper portion of the S-shaped cam hole 440, so that the roller shaft 406 is affected by the elastic force of the elastic unit 421 upwards. Thus, the disk is inserted into the compact disk player parallel to the roller 405. Furthermore, because the second hinge shaft of the roller assembly 425 is coupled to the elongate hole 428 of the main frame 402, the second hinge shaft can somewhat move along the elongate hole 428 vertically. Therefore, even when the roller assembly 425 or the upper and lower frames 403 and 401 are undesirably deformed, the roller 405 can be maintained in a parallel to the disk inserted between the disk guide plate 408 and the roller 405.

The disk is seated onto the turntable 404 of the main frame 402 through the above-mentioned disk insertion process. Thereafter, the outer edge of the disk pushes a lever trigger 424 of an arm clamp unit 419 which is provided above a rear portion of the main frame 402. At this time, the lever trigger 424 is coupled at a rotating shaft 423 thereof to a lever selector 422 which is provided in the arm clamp unit 419. By the above-mentioned movement of the lever trigger 424, the rack gear 414 coupled to the lever trigger 424 is actuated. Thus, the first lever unit 420, coupled at the rack gear coupling hole 441 thereof to the rack gear 414, is actuated.

The first lever unit 420 is connected to the second lever unit 420 by a symmetric arm 410 which is provided on a front end of the main frame 402. Therefore, when the first lever unit 420 is actuated, the symmetric arm 410 causes the second lever unit 420 to be actuated in conjunction with the first lever unit 420. By the operation of the first and second lever units 420, the roller shaft 406 is placed in the lower portions of the S-shaped cam holes 440, as shown in FIG. 9b.

The above-mentioned operation of the lever unit 420 is illustrated in FIGS. 9a and 9b. FIG. 9a illustrates the roller shaft 406 placed in the upper portion of the S-shaped cam hole 440 of the lever unit 420 during the disk insertion or ejection. When the roller shaft 406 is placed in the upper portion of the S-shaped cam hole 440, the upward elastic force of the elastic unit 421 is applied to the roller shaft 406. As such, the elastic unit 421 allows for stable disk ejection and insertion. FIG. 9b illustrates the operations of the lever unit 420 and the elastic unit 421 during the disk loading process. As shown in FIG. 9b, the roller shaft 406 is placed in the lower portion of the S-shaped cam hole 440 of the lever unit 420 during the disk loading process. At this time, the roller shaft 406 is not affected by any elastic force. As described above, the roller shaft 406 vertically moves under the guide of the S-shaped cam hole 440. The elastic force of the elastic unit 421 is applied to the roller shaft 406 only when the roller shaft 406 is placed in the upper portion of the S-shaped cam hole 440. Therefore, the operational load to actuate the lever unit 420 is reduced.

The operation of the loading device is described above when-the disk is inserted into the compact disk player. To eject the disk from the compact disk player, the loading device is operated in reverse, with respect to the above-mentioned disk inserting operation of the loading device.

As such, in the loading device of the present invention, the roller arm to support thereon the roller is provided into a single body, and the second shaft of the roller arm is inserted into the elongate hole of the main frame. Therefore, even when the upper or lower frame or the roller arm is undesirably deformed, the roller comes into parallel contact with the disk during the disk insertion or ejection. Accordingly, a disk insertion or ejection force is evenly applied from the roller to the disk, thus preventing a disk insertion or ejection error, thereby enhancing the ability and reliability of the product.

As described above, the present invention provides a loading device of a compact disk player for vehicles, in which, when a disk is inserted into or ejected from the compact disk player between a roller and a disk guide plate, the roller comes into parallel contact with the disk, so that, a force applied from the roller to the disk is regularly maintained, thus preventing a disk insertion or ejection error, thereby reducing the number of defective products, and enhancing the ability and reliability of the products.

Furthermore, a roller bushing, which serves as a connection unit used to assemble a roller assembly, is inserted into a roller arm. Thereafter, the roller bushing is rotated around a lower part thereof at a predetermined angle until a fastening protrusion provided on the roller bushing is coupled to a locking hole of the roller arm. As such, because the roller assembly is assembled using only the roller bushing through the above-mentioned assembling process, additional connection parts, such as washers, etc., and additional assembling processes are not necessary. Accordingly, costs of the products are reduced, and the process of manufacturing the disk loading device is simplified.

In addition, elastic force of two springs, one of which is provided on each lever unit, is applied or not applied to a roller shaft according to forward and backward movements of the lever units. Therefore, the disk loading device of the present invention reduces operation loads applied to the lever units during disk loading or ejection. That is, only when the disk is inserted into or ejected from the compact disk player, the elastic forces of the springs are applied to the roller shaft. Alternatively, when the lever units are actuated, the elastic forces of the springs are not applied to the roller shaft. Therefore, the disk loading device reduces the operational loads applied to the lever units during the disk loading or ejection, thus enhancing the reliability thereof.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A loading device of a compact disk player for vehicles, comprising:
a roller provided around a roller shaft which is mounted around an inlet of a main body of the compact disk player to be rotated by a drive motor;
a roller arm coupled to a main frame of the main body to support thereon the roller while allowing a vertical movement of the roller;
a connection unit to couple the roller shaft to the roller arm; and
a drive unit provided on each of both sides of the main frame to vertically actuate the roller shaft.

2. The loading device of the compact disk player according to claim 1, wherein the roller arm comprises on a first end thereof a first hinge shaft which is inserted into a coupling hole, provided on a predetermined portion of the main frame, using a coupling means, and on a second end thereof a second hinge shaft which is inserted into an elongate hole, provided on another predetermined portion of the main frame, to vertically move within a predetermined range,
wherein a movement of the second hinge shaft of the roller arm inserted in the elongate hole of the main frame compensates for an operational error caused on the roller arm and upper and lower frames when a disk is inserted into the compact disk player.

3. The loading device of the compact disk player according to claim 1, wherein the roller is rotated around the roller shaft while slipping on the roller shaft.

4. The loading device of the compact disk player according to claim 1, wherein the connection unit to couple the roller shaft to the roller arm comprises a roller bushing.

5. The loading device of the compact disk player according to claim 4, wherein the roller bushing comprises:
opposite sidepieces coupled to each other to provide an insert groove between them;
a connection part having a predetermined shape and provided on one of the opposite sidepieces; and
a fastening protrusion having a predetermined shape and provided on a predetermined portion of the connection part.

6. The loading device of the compact disk player according to claim 4 or 5, wherein the roller bushing is coupled to the roller shaft, the roller arm is inserted in the insert groove provided between the opposite sidepieces of the roller bushing, and the fastening protrusion provided on the connection part of the roller bushing is inserted into a coupling hole provided on a predetermined portion of the roller arm, so that the roller bushing allows the roller shaft and the roller arm to be actuated together.

7. The loading device of the compact disk player according to claim 1, wherein the drive unit provided on each of the both sides of the main frame comprises a lever unit and an elastic unit.

8. The loading device of the compact disk player according to claim 7, wherein the elastic unit comprises a bar spring or a leaf spring.

9. The loading device of the compact disk player according to claim 7, wherein the lever units of the drive units provided on the both sides of the main frame comprise first and second lever units respectively provided on right and left sides of the main frame, and each of the first and second lever units comprises:
a predetermined number of slide holes provided on the lever unit to respectively receive therein a predetermined number of coupling protrusions provided on each of the both sides of the main frame, so that the lever unit slides on each of the both sides of the main frame;
an S-shaped cam hole to allow the roller shaft to vertically move during a disk loading or ejecting; and
a predetermined number of support protrusions to support thereon the elastic unit which is provided to apply an upward elastic force to the roller shaft while the roller shaft is placed in an upper portion of the S-shaped cam hole,
wherein the first lever unit further comprises on a predetermined portion thereof a rack gear coupling hole to couple the first lever unit to a rack gear which is provided on a predetermined portion of the main frame to transmit a drive force from the drive motor to the first lever unit.

10. The loading device of the compact disk player according to claim 9, further comprising:
a symmetric arm provided under the roller arm to cause the first and second lever units to be operated in conjunction with each other.
